(19) United States
(12) Patent Application Publication
(10) Pub. No.: US 2022/0371672 A1
(43) Pub. Date: Nov. 24, 2022

(54) ELASTIC CRAWLER

(71) Applicant: BRIDGESTONE CORPORATION, Chuo-ku, Tokyo (JP)

(72) Inventor: Yutaka ABIKO, Chuo-ku, Tokyo (JP)

(73) Assignee: BRIDGESTONE CORPORATION, Chuo-ku, Tokyo (JP)

(21) Appl. No.: 17/754,607

(22) PCT Filed: Oct. 9, 2020
(86) PCT No.: PCT/JP2020/038361

§ 371 Date: Apr. 7, 2022

(30) Foreign Application Priority Data
Oct. 16, 2019 (JP) 2019-189788

(51) Int. Cl. B62D 55/24; B62D 55/26

(52) U.S. Cl. CPC B62D 55/244; B62D 55/26

(57) ABSTRACT

An elastic crawler with excellent durability is provided. The elastic crawler of the present disclosure includes a crawler body (2) made of an elastic material, and a plurality of protrusions (3) arranged on an inner circumferential surface (21) of the crawler body (2). The protrusions (3) each include an elastic material portion (31) and a resin member (32). The resin member (32) includes a crawler widthwise side face portion (321). The side face portion (321) has a crawler thicknesswise end face (325A) configured to form a boundary surface (BS) with the elastic material portion (31). The end face (325A) has a concave or convex shape in a crawler widthwise view.

### TECHNICAL FIELD

The present disclosure relates to an elastic crawler.

### BACKGROUND

As conventional elastic crawlers, there are rubber crawlers in which mountain-shaped resin members made of polyketone resin are disposed on rubber protrusions provided on an inner circumferential surface of a crawler body, in order to produce great effects on rubbing of rolling wheels and rubbing with drive pins (refer to, for example, Patent Literature (PTL) 1). According to such elastic crawlers, wear and the like of the rubber protrusions are suppressed, which enables to provide elastic crawlers with high durability.

### CITATION LIST

### Patent Literature

PTL 1: JP 2007-210447

### SUMMARY

### Technical Problem

However, rubber and resin are different materials. Accordingly, in the conventional elastic crawlers, when a resin member is subjected to large force, stress concentrates at a boundary surface between rubber and resin or in the vicinity of the boundary surface, which may affect durability in adhesion between a rubber protrusion and the resin member. Therefore, the conventional elastic crawlers described above have room for further improvement in terms of durability.

It would be helpful to provide an elastic crawler with excellent durability.

### Solution to Problem

An elastic crawler according to the present disclosure includes: a crawler body formed in the shape of an endless band and made of an elastic material; and a plurality of protrusions arranged at intervals on an inner circumferential surface of the crawler body, wherein the protrusions each include an elastic material portion and a resin member, the resin member includes a crawler widthwise side face portion, the crawler widthwise side face portion has a crawler thicknesswise end face configured to form a boundary surface with the elastic material portion, and the crawler thicknesswise end face has a concave or convex shape in a crawler widthwise view. The elastic crawler according to the present disclosure has excellent durability.

In the elastic crawler according to the present disclosure, the concave or convex shape is preferably, in the crawler widthwise view, a shape of an arc or mountain convex from the crawler thicknesswise end face to another crawler thicknesswise end face. In this case, the durability is further improved.

In the elastic crawler according to the present disclosure, a crawler widthwise outer corner of the crawler thicknesswise end face of the crawler widthwise side face portion is preferably, in a crawler widthwise cross-sectional view, in a rounded shape from an outer surface of the crawler widthwise side face portion toward an inner surface of the crawler widthwise side face portion. In this case, the durability is further improved.

In the elastic crawler according to the present disclosure, the crawler thicknesswise end face of the crawler widthwise side face portion preferably has a flat portion configured to continue to the crawler widthwise outer corner and to flatly extend toward the inner surface of the crawler widthwise side face portion, in the crawler widthwise cross-sectional view. In this case, the durability is further improved.

In the elastic crawler according to the present disclosure, a crawler widthwise inner corner of the crawler thicknesswise end face of the crawler widthwise side face portion is preferably, in the crawler widthwise cross-sectional view, in a rounded shape from the inner surface of the crawler widthwise side face portion toward the outer surface of the crawler widthwise side face portion. In this case, the durability is further improved.

In the elastic crawler according to the present disclosure, the resin member preferably includes two of the crawler widthwise side face portions arranged so as to face each other in a crawler width direction, and the resin member preferably further includes at least one connection portion configured to connect the two crawler widthwise side face portions. In this case, the durability is further improved.

In the elastic crawler according to the present disclosure, the crawler widthwise side face portion is preferably exposed from a side face of the elastic material portion in a crawler width direction. In this case, the durability is further improved.

### Advantageous Effect

According to the present disclosure, it is possible to provide the elastic crawler with excellent durability.

### BRIEF DESCRIPTION OF THE DRAWINGS

In the accompanying drawings:

FIG. 1 is a side view schematically illustrating an example of a crawler traveling apparatus to which an elastic crawler according to an embodiment of the present disclosure can be applied;

FIG. 2A is a cross-sectional view taken on the line A-A of FIG. 1;

FIG. 2B is an enlarged cross-sectional view of a region X of FIG. 2A;

FIG. 3A is a front view schematically illustrating a resin member of FIG. 2A;

FIG. 3B is a side view illustrating a crawler widthwise side face portion of the resin member of FIG. 2A, viewed from outside in a crawler width direction;

FIG. 4A is a side view of a variation of the crawler widthwise side face portion of the resin member illustrated in FIG. 3A, viewed from outside in the crawler width direction;

FIG. 4B is a side view of a variation of the crawler widthwise side face portion of the resin member illustrated in FIG. 4A, viewed from outside in the crawler width direction;

FIG. 4C is a side view of another variation of the crawler widthwise side face portion of the resin member illustrated in FIG. 3A, viewed from outside in the crawler width direction; and

FIG. 5 is a plan view schematically illustrating yet another variation of the crawler widthwise side face portion of the resin member of FIG. 3A.

### DETAILED DESCRIPTION

An elastic crawler according to an embodiment of the present disclosure will be described below with reference to the drawings. In this document, a “crawler width direction”, a “crawler thickness direction”, and a “crawler circumferential direction” refer to directions with respect to a crawler body (here, synonymous with the “elastic crawler”). In the drawings, the crawler width direction is indicated by the arrow WD, the crawler thickness direction is indicated by the arrow TD, and the crawler circumferential direction is indicated by the arrow CD. In this document, a “crawler inner circumferential side” and a “crawler outer circumferential side” also refer to an “inner circumferential side” and an “outer circumferential side” with respect to the crawler body (here, synonymous with the “elastic crawler”), respectively. Furthermore, in this document, a “crawler thicknesswise outer circumferential side” refers to a crawler outer circumferential side of both sides in the crawler thickness direction, and is also simply referred to as a “lower side”. In this document, a “crawler thicknesswise inner circumferential side” refers to a crawler inner circumferential side of both sides in the crawler thickness direction, and is also simply referred to as an “upper side”.

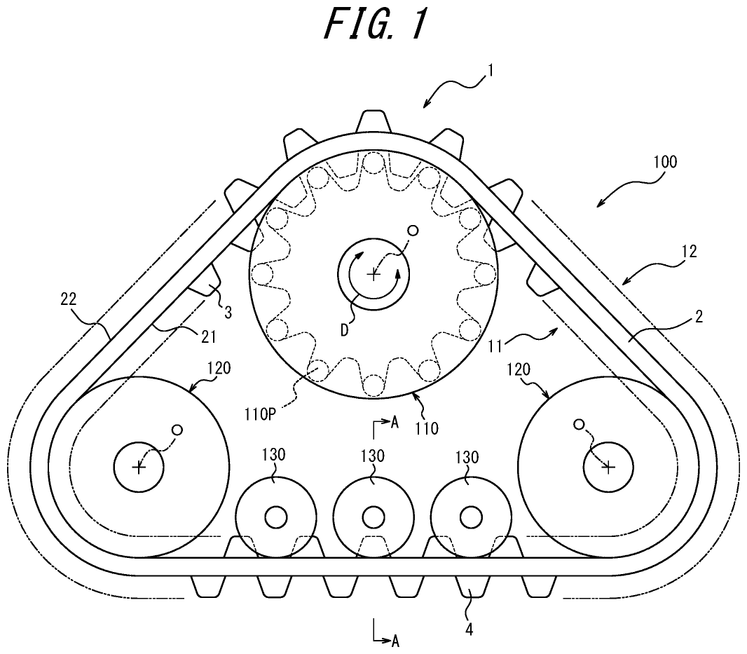

FIG. 1 is a side view schematically illustrating an example of a crawler traveling apparatus to which an elastic crawler 1 according to the embodiment of the present disclosure can be applied.

In FIG. 1, the reference numeral 100 indicates a crawler traveling apparatus to which the elastic crawler 1 can be applied. The crawler traveling apparatus 100 can be used, for example, for traveling of vehicles such as agricultural machines (tractors, combine harvesters, and the like) and construction machines (mini excavators, and the like). In this example, the crawler traveling apparatus 100 is configured as a traveling apparatus for a tractor.

In the example of FIG. 1, the crawler traveling apparatus 100 includes a drive wheel 110, driven wheels 120, and rolling wheels 130. These wheels are mounted on a fuselage of a vehicle (not illustrated). The drive wheel 110 is a cage-type sprocket. The cage-type sprocket has a plurality of pins 110P arranged with a constant pitch around a rotation axis O (in FIG. 1, only one of the pins is exemplarily indicated with the reference numeral). In this example, the crawler traveling apparatus 100 has one of the drive wheel 110, two of the driven wheels 120, and three of the rolling wheels 130. However, the numbers of the drive wheel 110, the driven wheels 120, and the rolling wheels 130 can be changed according to the configuration of the crawler traveling apparatus 100. Also, in this example, the pins 110P are each configured in the shape of a cylinder extending in the crawler width direction, but the configuration of the pins 110P can be changed as appropriate.

The elastic crawler 1 is looped on the drive wheel 110, the driven wheels 120, and the rolling wheels 130.

The elastic crawler 1 has a crawler body 2 that is formed in the shape of an endless band and made of an elastic material.

The elastic crawler 1 has, on an inner circumferential surface 21 of the crawler body 2, a plurality of protrusions 3 (in FIG. 1, only one of the protrusions 3 is exemplarily indicated with the reference numeral) that are arranged at intervals in the crawler circumferential direction and crawler width direction.

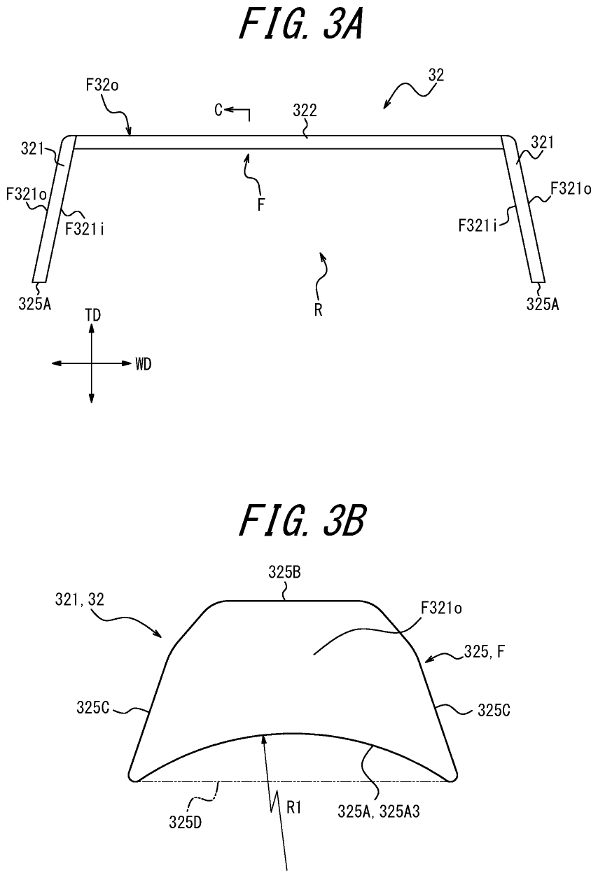

As illustrated in FIG. 1, the plurality of protrusions 3 each protrude from the inner circumferential surface 21 of the crawler body 2 to the crawler inner circumferential side. The plurality of protrusions 3 are arranged at regular intervals from each other in the crawler circumferential direction. In the present embodiment, an inner circumferential surface 11 of the elastic crawler 1 is constituted of the inner circumferential surface 21 of the crawler body 2 and outer surfaces F3o (refer to FIG. 3) of the protrusions 3.

Furthermore, with reference to FIG. 1, the elastic crawler 1 of the present embodiment has a plurality of lugs 4 (in FIG. 1, only one of the lugs 4 is exemplarily indicated with the reference numeral) that are arranged on an outer circumferential surface 22 of the crawler body 2 at intervals. The plurality of lugs 4 each protrude from the outer circumferential surface 22 of the crawler body 2 to the crawler outer circumferential side. The shape and arrangement of the lugs 4 are not limited to those illustrated in each drawing, and any shape and arrangement can be adopted. In the present embodiment, an outer circumferential surface 12 of the elastic crawler 1 is constituted of the outer circumferential surface 22 of the crawler body 2 and outer surfaces of the lugs 4. The lugs 4 are made of an elastic material. In this example, the elastic material is rubber. The lugs 4 may be integrally molded together with the crawler body 2, or may be vulcanized and bonded to the crawler body 2.

As illustrated by the arrow D in FIG. 1, when the drive wheel 110 rotates about the rotation axis O, the pins 110P come in contact with the protrusions 3 of the elastic crawler 1, which correspond to the respective pins 110P, in turn. The protrusions 3 have the function of transmitting driving force from the pins 110P to the crawler body 2 when the pins 110P of the drive wheel 110 contact the protrusions 3.

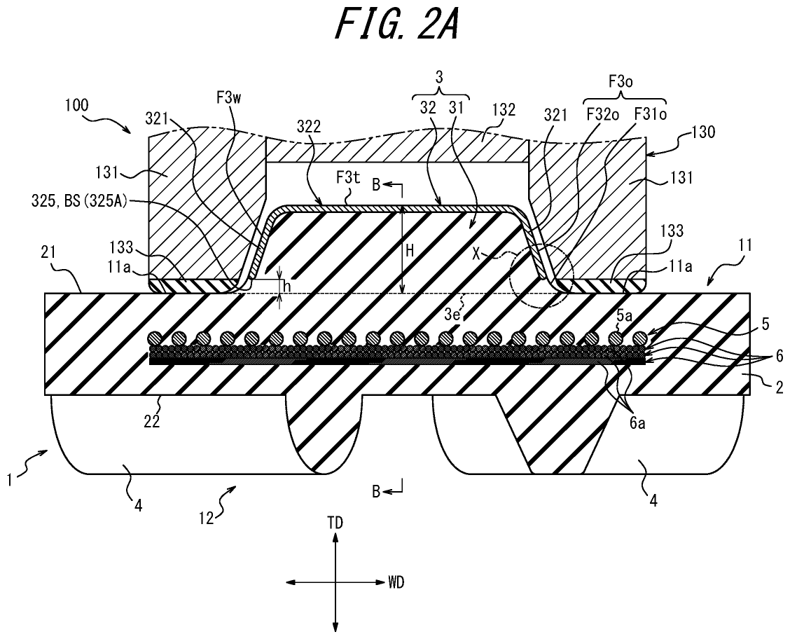

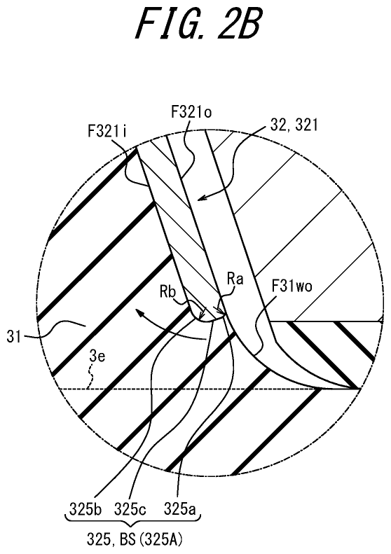

FIG. 2A is a cross-sectional view taken on the line A-A of FIG. 1. FIG. 2A is a cross-sectional view of the crawler traveling apparatus 100 in cross section in the crawler width direction.

The elastic crawler 1 in the present embodiment is a coreless rubber crawler. As illustrated in FIG. 2A, in the present embodiment, the protrusion 3 is located in the center of the crawler width direction.

In the present embodiment, the crawler body 2 includes a steel cord layer 5 and one or more layers (three layers in the example of the drawing) of reinforcing plies 6, which are buried in the crawler body 2. The steel cord layer 5 is constituted of a plurality of steel cords 5a (in FIG. 2A, only one of the steel cords 5a is exemplarily indicated with the reference numeral). Each of the reinforcing plies 6 is disposed on the crawler thicknesswise outer circumferential side relative to the steel cord layer 5. Each of the reinforcing plies 6 includes, for example, a plurality of cords 6a (in FIG. 2A, only one of the cords 6a is exemplarily indicated with the reference numeral) that are inclined with respect to the crawler circumferential direction. However, the reinforcing plies 6 may be omitted.

As exemplarily illustrated in the protrusion 3 of FIG. 2A, the plurality of protrusions 3 each include an elastic material portion 31 and a resin member 32.

In the present embodiment, as illustrated in FIG. 2A, the protrusion 3 consists of only two parts: the elastic material portion 31 and the resin member 32.

In the present embodiment, the elastic material portion 31 is an elastic protrusion provided on the inner circumferential surface 21 of the crawler body 2. The elastic material portion 31 absorbs shock from outside, while having strength against contact with the pin 110P. In the present embodiment, the elastic material portion 31 protrudes from the inner circumferential surface 21 of the crawler body 2 to the crawler thicknesswise inner circumferential side, as part of the protrusion 3. In the present embodiment, the elastic material portions 31, as part of the protrusions 3, are arranged in the center of the crawler width direction at regular intervals from each other in the crawler circumferential direction. The elastic material portion 31 is made of an elastic material. In this example, the elastic material is rubber, as with the lug 4.

The resin member 32 is a coating member that covers the elastic material portion 31. The resin member 32 suppresses wear and tear of the elastic material portion 31 and also reinforces the elastic material portion 31. In the present embodiment, the resin member 32 is formed of polyketone resin. In the present embodiment, the resin member 32 is embedded in the elastic material portion 31. In the present embodiment, part of the resin member 32 is exposed from the elastic material portion 31. The reference numeral F31o indicates an outer surface of the elastic material portion 31. The reference numeral F32o indicates an outer surface of the resin member 32. In the present embodiment, the outer surface F3o of the protrusion 3 is formed with the outer surface F31o of the elastic material portion 31 and the outer surface F32o of the resin member 32. The remaining part of the resin member 32, excluding the exposed part (outer surface F32o) of the resin member 32, is embedded in the elastic material portion 31. The outer surface F31o of the elastic material portion 31 and the outer surface F32o of the resin member 32 constitute the outer surface F3o of the protrusion 3. In the present embodiment, there is no step between the outer surface F31o of the elastic material portion 31 and the outer surface F32o of the resin member 32, and the outer surface F3o of the protrusion 3 is formed smoothly. In other words, the outer surface F3o of the protrusion 3 is in the same plane (coplanar) constituted of the outer surface F31o of the elastic material portion 31 and the outer surface F32o of the resin member 32. However, there may be a step between the outer surface F31o of the elastic material portion 31 and the outer surface F32o of the resin member 32. For example, the outer surface F32o of the resin member 32 may protrude outward from the outer surface F31o of the elastic material portion 31 to create a step in the outer surface F3o of the protrusion 3.

The protrusion 3 may be molded, for example, of unvulcanized rubber together with the elastic material portion 31, for example, with the resin member 32 as an insert. Alternatively, the protrusion 3 may be formed, for example, by bonding the resin member 32 onto the elastic material portion 31. In these cases, the protrusion 3 may be vulcanized and bonded onto the crawler body 2. Alternatively, the protrusion 3 may be molded, for example, of unvulcanized rubber together with the elastic material portion 31 and the crawler body 2, with the resin member 32 as an insert. That is, the protrusion 3 may be formed by chemically or physically bonding the elastic material portion 31 and the resin member 32.

Here, with reference to FIG. 3A, the resin member 32 includes crawler widthwise side face portions 321.

In the present embodiment, the resin member 32 is provided with two of the crawler widthwise side face portions 321 arranged so as to face each other in the crawler width direction. In the present embodiment, each of the two crawler widthwise side face portions 321 is formed from a thin plate panel.

In the present embodiment, the resin member 32 has at least one connection portion 322 that connects the two crawler widthwise side face portions 321. In the present embodiment, the resin member 32 includes one of the connection portion 322. That is, in the present embodiment, the two crawler widthwise side face portions 321 are connected by the one connection portion 322. In the present embodiment, the connection portion 322 of the resin member 32 is connected to crawler thicknesswise inner circumferential ends (upper ends) of the crawler widthwise side face portions 321. As illustrated in FIG. 3A, in the present embodiment, the connection portion 322 is also formed of a thin plate panel.

With reference to FIG. 3B, the reference numeral 325 indicates an end face of the crawler widthwise side face portion 321. The end face 325 is a face that forms the contour of the crawler widthwise side face portion 321 in a crawler widthwise view viewed from outside in the crawler width direction. In the present embodiment, the end face 325 of the crawler widthwise side face portion 321, as a crawler thicknesswise end face, has a crawler thicknesswise outer circumferential end face 325A and a crawler thicknesswise inner circumferential end face 325B. In addition, in the present embodiment, the end face 325 of the crawler widthwise side face portion 321 has two crawler circumferential end faces 325C, as crawler circumferential end faces. In the present embodiment, the contour of the crawler widthwise side face portion 321 is formed with the crawler thicknesswise outer circumferential end face 325A, the crawler thicknesswise inner circumferential end face 325B, and the two crawler circumferential end faces 325C.

The crawler widthwise side face portion 321 has a crawler thicknesswise end face that forms a boundary surface BS with the elastic material portion 31.

With reference to FIG. 2A, in the present embodiment, the crawler thicknesswise outer circumferential end face 325A forms the boundary surface BS between the elastic material portion 31 and the crawler widthwise side face portion 321 when the crawler widthwise side face portion 321 is embedded in the elastic material portion 31.

The crawler thicknesswise end face 325 includes a concave or convex shape in the crawler widthwise view.

With reference to FIG. 3B, in the present embodiment, the crawler thicknesswise outer circumferential end face 325A is in the shape of an arc convex from the crawler thicknesswise outer circumferential end face 325A toward the crawler thicknesswise inner circumferential end face 325B (the other crawler thicknesswise end face) in the crawler widthwise view. In the present embodiment, the crawler thicknesswise outer circumferential end face 325A is formed with only one arc-shaped portion 325A3 in the crawler widthwise view. Specifically, the crawler thicknesswise outer circumferential end face 325A is formed with the arc-shaped portion 325A3 formed with a radius of curvature R1.

Here, in FIG. 3B, a crawler thicknesswise outer circumferential end face 325D, in which the crawler thicknesswise outer circumferential end face of the crawler widthwise side face portion 321 of the resin member 32 is made flat in crawler widthwise view, is illustrated by the dashed line, as a comparative example.

In the case of the crawler thicknesswise outer circumferential end face 325D as the comparative example, as illustrated by the dashed line in FIG. 3B, when the resin member 32 receives driving force, the resin member 32 is easily subjected to force in the direction of peeling off from the elastic material portion 31 along the crawler thicknesswise outer circumferential end face 325D. In contrast, in the present embodiment, at the crawler widthwise side face portion 321 of the resin member 32, the crawler thicknesswise outer circumferential end face 325A of the crawler widthwise side face portion 321 is formed with the arc-shaped portion 325A3, as illustrated by the solid line in FIG. 3B. In this case, when the resin member 32 receives the driving force, the resin member 32 is hardly subjected to the force in the direction of peeling off from the elastic material portion 31 along the crawler thicknesswise outer circumferential end face 325A.

Thus, the elastic crawler 1 of the present embodiment can prevent the peeling of the resin member 32 from the elastic material portion 31 and the progress thereof, which results in excellent durability.

In the present embodiment, the concave or convex shape is made with the arc-shaped portion 325A3 that is convex from the crawler thicknesswise outer circumferential end face 325A toward the crawler thicknesswise inner circumferential end face 325B, in the crawler widthwise view. In this case, since the crawler thicknesswise outer circumferential end face 325A is formed into the shape of an arc, the crawler thicknesswise outer circumferential end face 325A does not have a complex shape, which results in the elastic crawler 1 of simple configuration with excellent durability.

The concave or convex shape may be in the shape of a mountain.

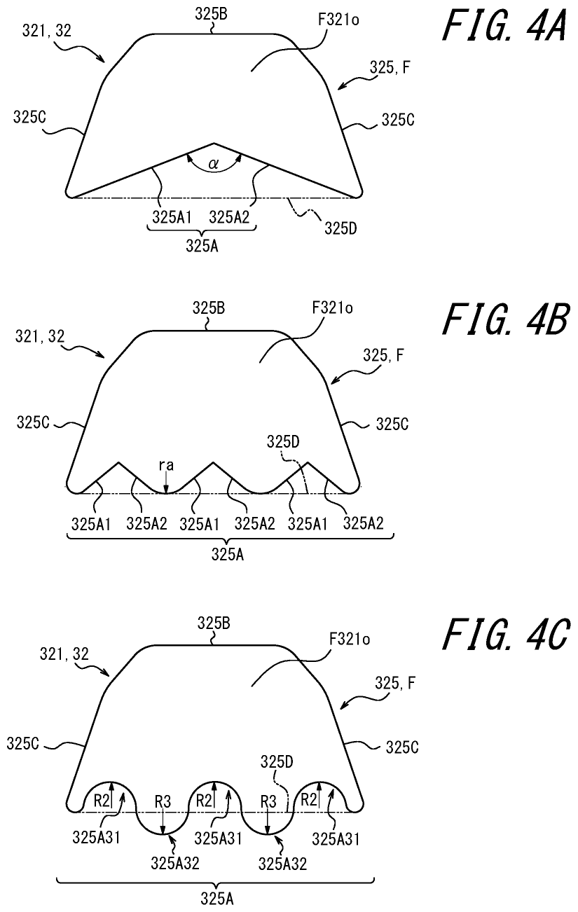

FIG. 4A is a side view that illustrates a variation of the crawler widthwise side face portion 321 of the resin member 32 illustrated in FIG. 3A, viewed from outside in the crawler width direction.

With reference to FIG. 4A, in the present embodiment, the crawler thicknesswise outer circumferential end face 325A is in the shape of a mountain that is convex from the crawler thicknesswise outer circumferential end face 325A toward the crawler thicknesswise inner circumferential end face 325B (the other crawler thicknesswise end face), in the crawler widthwise view. In the present embodiment, the crawler thicknesswise outer circumferential end face 325A is formed with only one mountain shape in the crawler widthwise view. Specifically, the crawler thicknesswise outer circumferential end face 325A is formed into the shape of a mountain constituted of two inclined faces, inclined faces 325A1 and 325A2. More specifically, the angle between the inclined face 325A1 and the inclined face 325A2 is an angle α. In the present embodiment, the intersection of the inclined face 325A1 and the inclined face 325A2 is a point at which two straight lines intersect in the crawler widthwise view. However, according to the present disclosure, the intersection of the inclined face 325A1 and the inclined face 325A2 may be a point of intersection with a curve with a radius of curvature r325, in the crawler widthwise view.

Here, also in FIG. 4A, a crawler thicknesswise outer circumferential end face 325D, in which the crawler thicknesswise outer circumferential end face of the crawler widthwise side face portion 321 of the resin member 32 is made flat in crawler widthwise view, is illustrated by the dashed line, as a comparative example.

With reference to FIG. 4A, in this example, in the crawler widthwise side face portion 321 of the resin member 32, the crawler thicknesswise outer circumferential end face 325A of the crawler widthwise side face portion 321 is formed into the shape of a mountain, as illustrated by the solid line in FIG. 4A. In this case also, when the resin member 32 receives driving force, the resin member 32 is hardly subjected to force in the direction of peeling off from the elastic material portion 31 along the crawler thicknesswise outer circumferential end face 325A. Therefore, in the case of this example, it is possible to prevent the peeling of the resin member 32 from the elastic material portion 31 and the progress thereof, which results in excellent durability.

In this example, the concave or convex shape is the shape of a mountain that is convex from the crawler thicknesswise outer circumferential end face 325A toward the crawler thicknesswise inner circumferential end face 325B, in the crawler widthwise view. In this case, since the crawler thicknesswise outer circumferential end face 325A is formed into the shape of a mountain, the crawler thicknesswise outer circumferential end face 325A does not have a complex shape, which results in the elastic crawler 1 of simple configuration with excellent durability.

The concave or convex shape may include a plurality of concave or convex shapes. The concave or convex shape may include, for example, a plurality of arc shapes. The concave or convex shape may be, for example, a plurality of mountain shapes. The concave or convex shape may be, for example, a shape that includes at least one combination of an arc shape and a mountain shape.

FIG. 4B is a side view of a variation of the crawler widthwise side face portion of the resin member 32 illustrated in FIG. 4A, viewed from outside in the crawler width direction.

In the variation illustrated in FIG. 4B, in the crawler widthwise side face portion 321 of the resin member 32, the crawler thicknesswise outer circumferential end face 325A of the crawler widthwise side face portion 321 is formed with a plurality (three, in this example) of mountain shapes. In this example, the crawler thicknesswise outer circumferential intersection of the inclined face 325A1 and the inclined face 325A2 is a point of intersection with a curve with a radius of curvature rc, in the crawler widthwise view. However, according to the present disclosure, the intersection of the inclined face 325A1 and the inclined face 325A2 may be a point at which two straight lines intersect, in the crawler widthwise view.

FIG. 4C is a side view of another variation of the crawler widthwise side face portion 321 of the resin member 32 illustrated in FIG. 3A, viewed from outside in the crawler width direction.

In the variation illustrated in FIG. 4C, in the crawler widthwise side face portion 321 of the resin member 32, the crawler thicknesswise outer circumferential end face 325A of the crawler widthwise side face portion 321 is formed with a plurality (five, in this example) of arc shapes. In particular, in this example, the crawler thicknesswise outer circumferential end face 325A includes three arc-shaped portions 325A31 that are convex from the crawler thicknesswise outer circumferential end face 325A toward the crawler thicknesswise inner circumferential end face 325B (the other crawler thicknesswise end face). In this example, these three arc shapes are formed with a radius of curvature r2. Also, in this example, the crawler thicknesswise outer circumferential end face 325A includes two arc-shaped portions 325A32 that are convex from the crawler thicknesswise inner circumferential end face 325B to the crawler thicknesswise outer circumferential end face 325A (the other crawler thicknesswise end face). In this example, these two arc-shaped portions 325A32 are formed with a radius of curvature r3. In this example, the radii r2 and r3 of curvature are centered on the crawler thicknesswise outer circumferential end face 325D, which is illustrated by the dashed line as a comparative example.

As illustrated in FIGS. 4B and 4C, when there is a plurality of the above-described concave or convex shapes, the elastic crawler 1 has more excellent durability.

With reference to FIG. 2A, the reference numeral 3e indicates a crawler thicknesswise outer circumferential end of the protrusion 3. The crawler thicknesswise outer circumferential end 3e of the protrusion 3 is a boundary surface between the protrusion 3 and the crawler body 2. That is, the crawler thicknesswise outer circumferential end 3e of the protrusion 3 is a lowest end of the protrusion 3. In the present embodiment, the crawler thicknesswise outer circumferential end 3e of the protrusion 3 coincides with the inner circumferential surface 21 of the crawler body 2. Also, in the present embodiment, the crawler thicknesswise outer circumferential end 3e of the protrusion 3 is a virtual bonding surface to the crawler body 2.

With reference to FIG. 2A, in the present embodiment, the height H of the protrusion 3 is a height in the crawler thickness direction. In the present embodiment, the height H of the protrusion 3 is a height from the crawler thicknesswise outer circumferential end 3e of the protrusion 3 to a top face F3t of the protrusion 3. In the present embodiment, in the crawler thicknesswise outer circumferential end face 325A of the crawler widthwise side face portion 321, the crawler thicknesswise outer circumferential end face 325A, as a lowest end of the resin member 32, is located at a height h (>0) from the crawler thicknesswise outer circumferential end 3e of the protrusion 3. The height h is a height in the crawler thickness direction. The height h can be set as appropriate according to various requirements such as the dimensions, shape, and required performances of an elastic crawler 1A. For example, in the present embodiment, the height h is set higher than the thickness of a rubber portion 133 (refer to FIG. 2) in the crawler thickness direction, so that the resin member 32 is prevented from directly contacting the rubber portion 133 of the rolling wheel 130, on which the elastic crawler 1A can be mounted.

In the present embodiment, the resin member 32 is embedded in the elastic material portion 31 so that the crawler thicknesswise outer circumferential end face 325A of the crawler widthwise side face portion 321 is located on the crawler thicknesswise inner circumferential side (upper side) relative to the crawler thicknesswise outer circumferential end 3e of the protrusion 3. In this case, the crawler thicknesswise outer circumferential end 3e of the protrusion 3 is originally a portion at which strain tends to concentrate due to contact with the rolling wheel 130 and the like. Accordingly, when the crawler thicknesswise outer circumferential end face 325A of the crawler widthwise side face portion 321 of the resin member 32 reaches the crawler thicknesswise outer circumferential end 3e of the protrusion 3, strain generated in the vicinity of the crawler thicknesswise outer circumferential end 3e of the protrusion 3 further increases due to difference in rigidity occurring at the boundary surface BS between the resin member 32 and the elastic material portion 31. However, locating the crawler thicknesswise outer circumferential end face 325A of the crawler widthwise side face portion 321 of the resin member 32 at a higher position than the crawler thicknesswise outer circumferential end 3e of the protrusion 3 prevents the generation of strain at the crawler thicknesswise outer circumferential end 3e of the protrusion 3 and in the vicinity of the crawler thicknesswise outer circumferential end 3e, thus further improving durability.

Here, FIG. 2B is an enlarged cross-sectional view of a region X of FIG. 2A.

As illustrated in FIG. 2B, in the present embodiment, the crawler thicknesswise outer circumferential end face 325A is constituted of a crawler widthwise outer corner 325a that continues to an outer surface F321o of the crawler widthwise side face portion 321 in a crawler widthwise cross-sectional view, a crawler widthwise inner corner 325b that continues to an inner surface F321i of the crawler widthwise side face portion 321, and a middle portion 325c that continues to the crawler widthwise outer corner 325a and the crawler widthwise inner corner 325b.

As illustrated in FIG. 2B, the crawler widthwise outer corner 325a of the crawler thicknesswise outer circumferential end face 325A is in a rounded (fillet) shape from the outer surface F321o of the crawler widthwise side face portion 321 toward the inner surface F321i of the crawler widthwise side face portion 321, in the crawler widthwise cross-sectional view.

As illustrated in FIG. 2B, in the present embodiment, the crawler widthwise outer corner 325a of the crawler thicknesswise outer circumferential end face 325A is contoured by an arc with a radius of curvature Ra, in the crawler widthwise cross-sectional view. Thus, in the present embodiment, the crawler widthwise outer corner 325a of the crawler thicknesswise outer circumferential end face 325A is filleted with a radius of curvature Ra along an extending direction of the crawler thicknesswise outer circumferential end face 325A. The fillet can be formed, for example, by R machining.

Also, as illustrated in FIG. 2B, in the present embodiment, the crawler thicknesswise outer circumferential end face 325A of the crawler widthwise side face portion 321 has a flat portion that continues to the crawler widthwise outer corner 325a and flatly extends to the inner surface F321i of the crawler widthwise side face portion 321, in the crawler widthwise cross-sectional view. In the present embodiment, the flat portion is the middle portion 325c of the crawler thicknesswise outer circumferential end face 325A of the crawler widthwise side face portion 321. In the present embodiment, the flat portion extends along the crawler width direction.

Also, as illustrated in FIG. 2B, in the present embodiment, the crawler widthwise inner corner 325b of the crawler thicknesswise outer circumferential end face 325A of the crawler widthwise side face portion 321 is formed into a rounded (fillet) shape from the inner surface F321i of the crawler widthwise side face portion 321 toward the outer surface F321o of the crawler widthwise side face portion 321, in the crawler widthwise cross-sectional view. As illustrated in FIG. 2B, in the present embodiment, the crawler widthwise inner corner 325b of the crawler thicknesswise outer circumferential end face 325A of the crawler widthwise side face portion 321 is contoured by an arc with a radius of curvature Rb, in the crawler widthwise cross-sectional view. As described above, in the present embodiment, the crawler widthwise inner corner 325b of the crawler thicknesswise outer circumferential end face 325A is filleted with a radius of curvature Rb along the extending direction of the crawler thicknesswise outer circumferential end face 325A. The fillet can also be formed, for example, by R machining. It is preferable that the radius of curvature Ra is set to be larger than the radius of curvature Rb. In the present embodiment, the radius of curvature Ra is set to be larger than the radius of curvature Rb. However, according to the present disclosure, the radius of curvature Ra may be set to be equal to or smaller than the radius of curvature Rb.

By the way, as illustrated in FIG. 2A, in the crawler traveling apparatus 100 of this example, the rolling wheel 130 includes two rolling wheel bodies 131 spaced apart in the crawler width direction, and a connecting shaft 132 that connects the rolling wheel bodies 131. Furthermore, in this example, an outer circumferential surface of each of the rolling wheel bodies 131 is covered with the rubber portion 133. In the crawler traveling apparatus 100 of this example, the rolling wheels 130 are configured to each roll on a rolling wheel passing surface 11a. That is, the elastic crawler 1 according to the present embodiment is configured to pass over the rolling wheels 130 when traveling.

In the crawler traveling apparatus 100 of this example, the protrusions 3 of the elastic crawler 1 are configured to be each located inside the two rolling wheel bodies 131 in the crawler width direction. The protrusions 3 have the function of guiding the rolling wheels 130 in the crawler width direction by crawler widthwise side faces F3w of the protrusions 3. This prevents the elastic crawler 1A from falling off (i.e., the elastic crawler 1A coming off the rotating body such as the rolling wheels 130). In this example, the driven wheels 120 are also configured in the same way as the rolling wheels 130. This also prevents the elastic crawler 1A from falling off the driven wheels 120.

In the elastic crawler according to the present disclosure, the crawler widthwise side face portion 321 is exposed from a crawler widthwise side face F31wo (refer to FIG. 2B) of the elastic material portion 31. In this case, the crawler widthwise side face portions 321 of the resin member 32 protect the elastic material portion 31, thus suppressing wear, deformation, and the like of the protrusion 3, which results in further improvement in durability.

With reference to FIG. 2B, in the present embodiment, the outer surface F321o of the crawler widthwise side face portion 321 is exposed from the crawler widthwise side face F31wo of the elastic material portion 31, as part of the resin member 32, and constitutes the crawler widthwise side face F3w of the protrusion 3. In this case, the protrusion 3 can be protected by the crawler widthwise side face portions 321 of the resin member 32. The resin member 32 is formed of a resin material having a lower coefficient of friction than rubber. Therefore, the protrusions 3 each constituted of the elastic material portion 31 and the resin member 32, as in the present embodiment, prevent the elastic crawler 1 from being falling off the protrusions 3, because even if the rotating body such as the rolling wheel 130 tries to ride up on the protrusion 3, the rotating body slides down.

On the other hand, in a case in which the protrusion 3 is constituted of the elastic material portion 31 and the resin member 32, there is difference in rigidity, due to difference in materials, based on the boundary surface BS formed between the elastic material portion 31 and the resin member 32. For this reason, when strain concentrates at the boundary surface BS between the elastic material portion 31 and the resin member 32 or in the vicinity of the boundary surface BS, there is a concern that the elastic material portion 31 may crack.

On the other hand, with reference to FIG. 2B, in the present embodiment, in the crawler widthwise side face portion 321 of the resin member 32, the crawler widthwise outer corner 325a of the crawler thicknesswise outer circumferential end face 325A is formed into a rounded shape from the outer surface F321o of the crawler widthwise side face portion 321 toward the inner surface F321i. In the present embodiment, the boundary surface BS between the elastic material portion 31 and the resin member 32 is in a rounded chamfered shape. In this case, even when a large load is applied to the crawler widthwise side face portion 321 of the resin member 32 toward inside in the crawler width direction, strain does not concentrate at the boundary surface BS between the elastic material portion 31 and the resin member 32 or in the vicinity of the boundary surface BS, in particular, at the boundary surface BS between the crawler widthwise outer corner 325a of the crawler thicknesswise outer circumferential end face 325A of the crawler widthwise side face portion 321 and the elastic material portion 31 or in the vicinity of the boundary surface BS toward the inside in the crawler width direction, and therefore the generation of strain at the boundary surface BS between the crawler widthwise outer corner 325a and the elastic material portion 31 or in the vicinity of the boundary surface BS is reduced. Therefore, according to the present embodiment, the generation of a crack from the boundary surface BS between the elastic material portion 31 and the crawler thicknesswise outer circumferential end face 325A of the crawler widthwise side face portion 321 of the resin member 32 or the vicinity of the boundary surface BS toward inside in the crawler width direction is prevented. In this case, the direction of shear force generated in the elastic material portion 31 is, as illustrated by an arrow in FIG. 2B, in the direction of coming around the inside of the crawler widthwise side face portion 321 of the resin member 32 along the rounded shape, which forms the crawler widthwise outer corner 325a of the crawler thicknesswise outer circumferential end face 325A. Therefore, according to the present embodiment, even if a crack toward the inside in the crawler width direction is generated, the propagation of the crack is prevented.

In the present embodiment, the middle portion 325c of the crawler thicknesswise outer circumferential end face 325A is a flat portion that continues to the crawler widthwise outer corner 325a and extends flatly toward the inner surface F321i of the crawler widthwise side face portion 321. In this case, leaving the flat portion between the crawler widthwise outer corner 325a of the crawler thicknesswise outer circumferential end face 325A and the crawler widthwise inner corner 325b further prevents the generation of a crack and the propagation of the crack, which further improves durability.

In the present embodiment, the inner corner 325b of the crawler thicknesswise outer circumferential end face 325A of the crawler widthwise side face portion 321 of the resin member 32 is in a rounded shape from the inner surface F321i of the crawler widthwise side face portion 321 toward the outer surface F321o. In this case, compared to a case in which the crawler widthwise inner corner 325b of the crawler thicknesswise outer circumferential end face 325A of the crawler widthwise side face portion 321 is not formed in the above-described rounded shape, the generation of a crack and the propagation of the crack are more prevented, thereby further improving durability.

As illustrated in FIG. 3B, in the present embodiment, in the crawler widthwise side face portion 321 of the resin member 32, the crawler thicknesswise outer circumferential end face 325A continues to the two crawler circumferential end faces 325C. Also in the two crawler circumferential end faces 325C, as illustrated in FIG. 2B, the crawler widthwise outer corner 325a and the crawler widthwise inner corner 325b are in a rounded (fillet) shape, and the middle portion 325c is flat.

In the present embodiment, the crawler widthwise side face portions 321 of the resin member 32 are connected in a cantilevered state on the crawler thicknesswise inner circumferential side (upper side) via the connection portion 322. In this case, the crawler widthwise side face portions 321 of the resin member 32 move easily against the connection portion 322 based on the crawler thicknesswise inner circumferential side. Accordingly, in the protrusion 3, strain easily concentrates at the boundary surface BS between the crawler thicknesswise outer circumferential end face 325A of the crawler widthwise side face portion 321 and the elastic material portion 31 and in the vicinity of the boundary surface BS, due to contact with the rolling wheels 13 and the like.

In contrast, in the present embodiment, in at least the crawler thicknesswise outer circumferential end face 325A of the resin member 32, the crawler widthwise outer corner 325a and the crawler widthwise inner corner 325b are in a rounded (fillet) shape, and the middle portion 325c is flat, the generation of a crack and the propagation of the crack are more prevented, which further improves durability.

Also with reference to FIG. 3A, in the present embodiment, the resin member 32 includes the two crawler widthwise side face portions 321 that are arranged so as to face each other in the crawler width direction, and the at least one connection portion 322 that connects the two crawler widthwise side face portions 321. In this case, in the resin member 32, the two crawler widthwise side face portions 321 are connected by the connection portion 322, as one rigid body, thereby improving the rigidity of the entire resin member 32, which further improves durability. In this case, a portion of the protrusion 3 excluding the two crawler widthwise side face portions 321 and the connection portion 322 of the resin member 32 is formed with the elastic material portion 31, so a large adhesion area between the resin member 32 and the elastic material portion 31 is secured. Therefore, the resin member 32 and the elastic material portion 31 are bonded more firmly. Accordingly, in this case, the durability of the entire protrusion 3 is improved, and the durability is further enhanced.

By the way, in the present embodiment, the resin member 32 is configured as a thin plate member. In the present embodiment, the resin member 32 is integrally formed as one component by injection molding using thermoplastic resin or the like. In the present embodiment, as illustrated in FIG. 3B, the length of the connection portion 322 in the crawler circumferential direction is shorter than the length of the crawler widthwise side face portion 321 of the resin member 32 in the crawler circumferential direction. The connection portion 322 of the resin member 32 is connected to upper ends of the crawler widthwise side face portions 321 of the resin member 32. Accordingly, as illustrated in FIG. 3A, the resin member 32 has a region R that accommodates (contains) the elastic material portion 31 constituting the protrusion 3, between the crawler widthwise side face portions 321 and the connection portion 322. In this case, a large embedded surface F of the resin member 32, which contacts the elastic material portion 31, is secured, and hence a large adhesion area between the elastic material portion 31 and the resin member 32 is secured. As a result, according to the present embodiment, the durability of the protrusion 3 and, in turn, the durability of the elastic crawler 1A can be further improved.

In the present embodiment, the resin member 32 preferably has at least one of a concave portion and a convex portion in a part contacting the elastic material portion 31, that is, the embedded surface F. In this case, the large embedded surface F of the resin member 32, which contacts the elastic material portion 31, is secured, and thus a large adhesion area between the elastic material portion 31 and the resin member 32 is secured. As a result, bonding force between the elastic material portion 31 and the resin member 32 is increased, and the durability of the protrusion 3, and, in turn, the durability of the elastic crawler 1A can be further improved.

With reference to FIGS. 3A and 3B, the embedded surface F of the resin member 32 includes the crawler widthwise side face portions 321 and the connection portion 322 of the resin member 32. The above-described concave portion or the convex portion includes a single convex portion, embossing, grain, or the like. In the present embodiment, the entire embedded surface F may be provided with a concave or convex portion, such as embossing. This improves adhesion between the elastic material portion 31 and the resin member 32. In particular, when the elastic material portion 31 is rubber, adhesion with the resin member 32 is improved. On the other hand, the outer surface F32o of the resin member 32 preferably has reduced frictional resistance, in consideration of contact with the rolling wheels 130 and the like. For this reason, it is preferable that the outer surface F32o of the resin member 32 is not subjected to surface roughness processing, such as provision of the above-described convex portion. According to the present disclosure, the end faces 325 of the resin member 32 may also be included in the embedded surface F. The embedded surface F may also include a reinforcing portion 324.

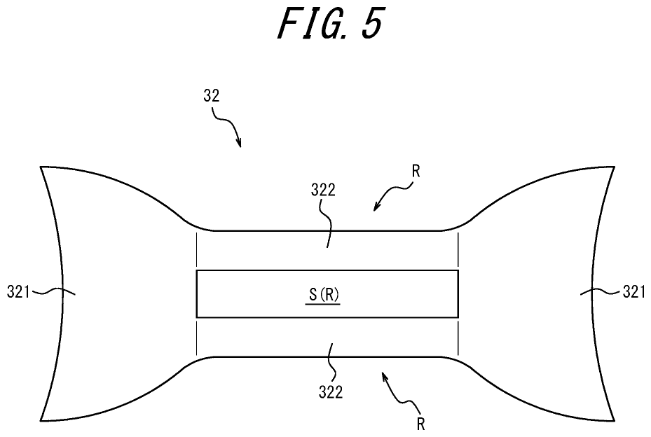

FIG. 5 is a plan perspective view schematically illustrating a resin member 32 constituting part of a protrusion 3 of an elastic crawler 1B. In the present embodiment, the resin member 32 includes two of the connection portions 322 that connect the two crawler widthwise side face portions 321. In this case, since the rigidity of the entire resin member 32 is improved, the durability of the protrusion 3 of the elastic crawler 1B and, in turn, the durability of the elastic crawler 1B can be further improved. Also, in the present embodiment, a gap S is formed between the two connection portions 322. In the present embodiment, as well as the region R of the resin member 32 according to the first embodiment, the gap S functions as the region R, and part of the elastic material portion 31 is accommodated in the gap S. In this case, a large embedded surface F of the resin member 32, which contacts the elastic material portion 31, is secured, and thus a large adhesion area between the elastic material portion 31 and the resin member 32 is secured. Therefore, the durability against adhesion between the elastic material portion 31 and the resin member 32 is increased, and as a result, the durability of the protrusion 3 of the elastic crawler 1B and, in turn, the durability of the elastic crawler 1B can be improved.

The foregoing disclosure discloses only a few embodiments of the present disclosure, and various modifications are possible in accordance with the claims. For example, according to the present disclosure, the resin member 32 may be constituted of only the crawler widthwise side face portions 321. In this case, of the end faces 325 of the crawler widthwise side face portion 321 of the resin member 32, at least one of the crawler thicknesswise outer circumferential end face and/or the crawler thicknesswise inner circumferential end face may be shaped as described above.

Some or other parts of the resin member 32 may be separated. In the present embodiment, in the resin member 32, the crawler widthwise side face portions 321 and the connection portion 322 are integrated into one unit, but may be configured as separate members. The connection portion 322 of the resin member 32 may be integral with the elastic material portion 31. In this case, the connection portion 322 of the resin member 32 is not exposed from the elastic material portion 31. The various configurations employed in each of the above-described embodiments may be used in combination with each other. Also, the various configurations employed in each of the above-described embodiments can be replaced with each other as appropriate.

### REFERENCE SIGNS LIST

1 Elastic crawler
2 Crawler body
12 Outer circumferential surface of crawler body
3 Protrusion
3e Crawler thicknesswise outer circumferential end of protrusion
4 Lug
32 Resin member
321 Crawler widthwise side face portion of resin member
322 Connection portion of resin member
325 End face of crawler widthwise side face portion
325A Crawler thicknesswise outer circumferential end face of crawler widthwise side face portion
325A1 Inclined face
325A2 Inclined face
325A3 Arc-shaped portion
325A31 Arc-shaped portion
325A32 Arc-shaped portion
325B Crawler thicknesswise inner circumferential end face of crawler widthwise side face portion
325C Crawler circumferential end face of crawler widthwise side face portion
325a Crawler widthwise outer corner
325b Crawler widthwise inner corner
325c Middle portion (flat portion)
F321o Crawler widthwise outer surface of crawler widthwise side face portion
F321i Crawler widthwise inner surface of crawler widthwise side face portion
BS Boundary surface
F Embedded surface of resin member
100 Crawler traveling apparatus
110 Drive wheel (rotating body)
110P Pin
120 Driven wheel (rotating body)
130 Rolling wheel (rotating body)

1. An elastic crawler comprising:
a crawler body formed in a shape of an endless band and made of an elastic material; and
a plurality of protrusions arranged at intervals on an inner circumferential surface of the crawler body,
wherein
the protrusions each include an elastic material portion and a resin member,
the resin member includes a crawler widthwise side face portion,
the crawler widthwise side face portion has a crawler thicknesswise end face configured to form a boundary surface with the elastic material portion, and
the crawler thicknesswise end face has a concave or convex shape in a crawler widthwise view.

2. The elastic crawler according to claim 1, wherein the concave or convex shape is, in the crawler widthwise view, a shape of an arc or mountain convex from the crawler thicknesswise end face to another crawler thicknesswise end face.

3. The elastic crawler according to claim 1, wherein a crawler widthwise outer corner of the crawler thicknesswise end face of the crawler widthwise side face portion is, in a crawler widthwise cross-sectional view, in a rounded shape from an outer surface of the crawler widthwise side face portion toward an inner surface of the crawler widthwise side face portion.

4. The elastic crawler according to claim 3, wherein the crawler thicknesswise end face of the crawler widthwise side face portion has a flat portion configured to continue to the crawler widthwise outer corner and to flatly extend toward the inner surface of the crawler widthwise side face portion, in the crawler widthwise cross-sectional view.

5. The elastic crawler according to claim 3, wherein a crawler widthwise inner corner of the crawler thicknesswise end face of the crawler widthwise side face portion is, in the crawler widthwise cross-sectional view, in a rounded shape from the inner surface of the crawler widthwise side face portion toward the outer surface of the crawler widthwise side face portion.

6. The elastic crawler according to claim 1, wherein
the resin member includes two of the crawler widthwise side face portions arranged so as to face each other in a crawler width direction, and
the resin member further includes at least one connection portion configured to connect the two crawler widthwise side face portions.

7. The elastic crawler according to claim 1, wherein the crawler widthwise side face portion is exposed from a side face of the elastic material portion in a crawler width direction.

8. The elastic crawler according to claim 2, wherein a crawler widthwise outer corner of the crawler thicknesswise end face of the crawler widthwise side face portion is, in a crawler widthwise cross-sectional view, in a rounded shape from an outer surface of the crawler widthwise side face portion toward an inner surface of the crawler widthwise side face portion.

9. The elastic crawler according to claim 2, wherein
the resin member includes two of the crawler widthwise side face portions arranged so as to face each other in a crawler width direction, and
the resin member further includes at least one connection portion configured to connect the two crawler widthwise side face portions.

10. The elastic crawler according to claim 2, wherein the crawler widthwise side face portion is exposed from a side face of the elastic material portion in a crawler width direction.

11. The elastic crawler according to claim 3, wherein
the resin member includes two of the crawler widthwise side face portions arranged so as to face each other in a crawler width direction, and
the resin member further includes at least one connection portion configured to connect the two crawler widthwise side face portions.

12. The elastic crawler according to claim 3, wherein the crawler widthwise side face portion is exposed from a side face of the elastic material portion in a crawler width direction.

13. The elastic crawler according to claim 4, wherein a crawler widthwise inner corner of the crawler thicknesswise end face of the crawler widthwise side face portion is, in the crawler widthwise cross-sectional view, in a rounded shape from the inner surface of the crawler widthwise side face portion toward the outer surface of the crawler widthwise side face portion.

14. The elastic crawler according to claim 4, wherein
the resin member includes two of the crawler widthwise side face portions arranged so as to face each other in a crawler width direction, and
the resin member further includes at least one connection portion configured to connect the two crawler widthwise side face portions.

15. The elastic crawler according to claim 4, wherein the crawler widthwise side face portion is exposed from a side face of the elastic material portion in a crawler width direction.

16. The elastic crawler according to claim 5, wherein
the resin member includes two of the crawler widthwise side face portions arranged so as to face each other in a crawler width direction, and
the resin member further includes at least one connection portion configured to connect the two crawler widthwise side face portions.

17. The elastic crawler according to claim 5, wherein the crawler widthwise side face portion is exposed from a side face of the elastic material portion in a crawler width direction.

18. The elastic crawler according to claim 8, wherein the crawler thicknesswise end face of the crawler widthwise side face portion has a flat portion configured to continue to the crawler widthwise outer corner and to flatly extend toward the inner surface of the crawler widthwise side face portion, in the crawler widthwise cross-sectional view.

19. The elastic crawler according to claim 8, wherein a crawler widthwise inner corner of the crawler thicknesswise end face of the crawler widthwise side face portion is, in the crawler widthwise cross-sectional view, in a rounded shape from the inner surface of the crawler widthwise side face portion toward the outer surface of the crawler widthwise side face portion.

20. The elastic crawler according to claim 8, wherein
the resin member includes two of the crawler widthwise side face portions arranged so as to face each other in a crawler width direction, and
the resin member further includes at least one connection portion configured to connect the two crawler widthwise side face portions.
